(19) United States
(12) Patent Application Publication
(10) Pub. No.: US 2005/0225598 A1
(43) Pub. Date: Oct. 13, 2005

(54) Fluid ejection devices and operation thereof

(76) Inventor: Peter Guy Howard, Junction City, OR (US)

Correspondence Address: HEWLETT-PACKARD COMPANY;Intellectual Property Administration, P.O. Box 272400, Fort Collins, CO, 80527-2400, US

(21) Appl. No.: 10/822,956

(22) Filed: Apr. 13, 2004

(51) Int. Cl. B41J 2/205

(52) U.S. Cl. 347/52

(57) ABSTRACT

Briefly described, embodiments of this disclosure include systems and methods for ejecting fluid from a fluid ejection system. One exemplary method, among others, includes: heating a fluid to a lower threshold using an electric heating layer; heating the fluid to an upper threshold using laser energy; and ejecting a volume of fluid.

### BACKGROUND

An inkjet printing system, as one embodiment of a fluid ejection system, may include a printhead assembly, an ink supply which supplies liquid ink to the printhead assembly, and an electronic controller which controls the printhead assembly. The printhead assembly, as one embodiment of a fluid ejection assembly, ejects ink drops through a plurality of orifices or nozzles and toward a print medium, such as a sheet of paper, so as to print onto the print medium. Typically, the orifices are arranged in one or more arrays such that properly sequenced ejection of ink from the orifices causes characters or other images to be printed upon the print medium as the printhead assembly and the print medium are moved relative to each other.

Typically, the printhead assembly ejects the ink drops through the nozzles by rapidly heating a small volume of ink located in vaporization chambers with small electric heaters, such as thin film resistors, often referred to as firing resistors. Heating the ink causes the ink to vaporize and be ejected from the nozzles. Typically, for one dot of ink, a remote printhead assembly controller typically located as part of the processing electronics of a printer, controls activation of an electrical current from a power supply external to the printhead assembly. The electrical current is passed through a selected firing resistor to heat the ink in a corresponding selected vaporization chamber.

One method of controlling the application of the electrical current through the selected firing resistor is to couple a switching device, such as a field effect transistor (FET), to each firing resistor. In one printhead arrangement, the firing resistors are grouped together in primitives, with a single power lead providing power to the source or drain of each FET for each firing resistor in a primitive. Each FET in a primitive has a separately energizable address lead coupled to its gate, with each address lead coupled to its gate, with each address lead shared by multiple primitives. In a typical printing operation, the address leads are controlled so that only a single firing resistor in a primitive is activated at a given time.

In one arrangement, the address lead coupled to the gate of each FET is controlled by a combination of nozzle data, nozzle addresses, and a fire pulse. The nozzle data is typically provided by the electronic controller of the printer and represents the actual data to be printed. The fire pulse controls the timing of the activation of the electrical current through the selected firing resistor. Typical conventional inkjet printing systems employ the electronic controller to control the timing related to the fire pulse. The nozzle address is cycled through all nozzle addresses to control the nozzle firing order so that all nozzles can be fired, but only a single nozzle in a primitive is fired at a given time.

While such arrangements are effective in controlling nozzle firing, connections between remote elements and the printhead assembly and between elements on the printhead assembly itself can become complex, especially as the number of nozzles on the print head area increase. An example of such a complex system is referred to as a wide-array inkjet printing system. A page-wide array printhead spans the width of an entire page of media (e.g., 8.5 inches for paper utilized in the United States) and is fixed relative to the media path. A page-wide array printhead assembly includes a page-wide array printhead with thousands of nozzles that span the entire page width. The page-wide array printhead assembly is typically oriented orthogonal to the paper path. During operation, the page-wide array printhead assembly is fixed, while the media is moved under the assembly. The page-wide array printhead assembly prints one or more lines at a time as the page moves relative to the assembly.

A problem with page-wide array printing includes maintaining accurate drop weights while at the same time increasing operating speeds of a page wide array printhead. Another problem with page-wide array printing includes the large amounts of energy required to cause ink drop ejection.

### BRIEF DESCRIPTION OF THE DRAWINGS

Many aspects of this disclosure can be better understood with reference to the following drawings. The components in the drawings are not necessarily to scale. Moreover, in the drawings, like reference numerals designate corresponding parts throughout the several views.

FIG. 1 illustrates an embodiment of a fluid ejection system.

FIG. 2A illustrates an embodiment of a page-wide array printhead assembly, while FIG. 2B illustrates a cross-section of a representative nozzle system (cross section A-A of FIG. 2A).

FIG. 3 is a graph illustrating an embodiment of an energy curve for ejecting a fluid drop from a thermal inkjet.

FIG. 4 includes a graph illustrating embodiments of representative heating waveforms.

### DETAILED DESCRIPTION

Fluid ejection systems and methods of use thereof are provided. In particular, the embodiments relate to laser driven thermal fluid ejection systems. In one embodiment, the fluid ejection system uses a two-part heating process to emit or eject fluid (e.g., pigment-based inkjet inks and/or dye-based inkjet inks) from a page-wide array printhead assembly. In particular, energy from a first heating source (e.g., a resistor) in a page-wide array printhead assembly initially heats the fluid to a first threshold. In addition, energy from a second heating source (e.g., a laser system) heats the fluid from the first threshold to a second threshold, which causes a volume of fluid (e.g., a drop) to be ejected from the page-wide array printhead assembly onto a media (e.g., paper or transparency).

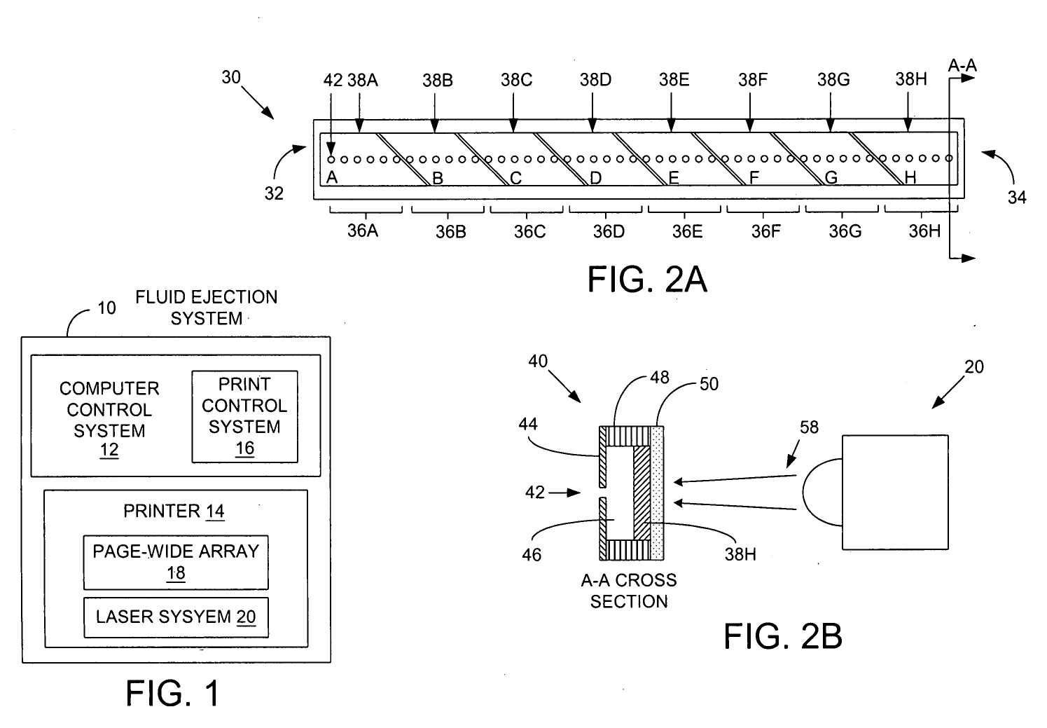

FIG. 1 illustrates a block diagram of a representative fluid ejection system 10 (i.e., page-wide array printer system 10) that includes a computer control system 12 and a printer 14, which is one embodiment of a fluid ejection system 10. The computer control system 12 includes a print control system 16. The printer 14 includes a page-wide array 18 and a laser system 20, which is one embodiment of a fluid ejection system 10. The print control system 16 is operative to control the printing process of the printer 14.

The page-wide array 18 includes, but is not limited to, a page-wide array printhead assembly 30, which is illustrated in FIG. 2A. The page-wide array printhead assembly 30 includes a first end 32 and a second end 34. In addition, the page-wide array printhead assembly 30 includes a plurality of areas 36A . . . 36H located from the first end 32 to the second end 34 of the page-wide array printhead assembly 30. Each area 36A . . . 36H includes a portion of a heating layer 38A . . . 38H and a plurality of nozzles systems 40 (FIG. 2B). A subset of the plurality of nozzles are disposed within each heating layer 38A . . . 38H. Although the page-wide array printhead assembly 30 is depicted as being divided into eight areas in FIG. 2A, page-wide array printhead assemblies 30 can be divided into any number of desired areas (e.g., 48 to 100 areas). In addition, although each area 36A . . . 36H is depicted as including six nozzle systems 40, each area can include any number of desired nozzles (e.g., from about 50 to 100 nozzle systems 40). In one embodiment, the page-wide array 18 includes about 2000 to 8000 nozzle systems. In other embodiments, the number of nozzle systems may vary depending on the requirements of the system (e.g., resolution and/or speed).

Heating layers 38A . . . 38H include, but are not limited to, one or more electronic heating layer(s) and a plurality of photon absorbing layers. In one embodiment, the one or more electronic heating layers include a resistive layer and a conductive layer (e.g., a heating resistor). In addition, electronic heating layers may be coupled contacts located on the page-wide array 18 via conductive paths or electrodes as are well known in the art. The contacts can then be coupled to the printer 14 to provide energy to the electronic heating layers. In one embodiment, the resistive layer and conductive layer can be formed using materials such as tantalum and aluminum. In one embodiment, the photon absorbing layer includes materials such as tantalum nitride.

In certain embodiments, the one or more electronic heating layers are separated from the photon absorbing layer via electrically insulating layers. In other embodiments, electrically insulating layers are not utilized. In further embodiments, one or more of the photon absorbing layers and electronic heating layers are substantially coplanar but located at different positions in a single layer. In additional embodiments, electronic heating layers are located proximate to fluid (ink) chamber 46, while photon absorbing layers are located proximate transparent substrate 50. (FIG. 2B)

In one embodiment, the heating layer 38A . . . 38H is a single layer, where the electronic heating layer and the photon absorbing layer are formed of the same material. In another embodiment, the heating layer 38A . . . 38H includes at least two layers, where at least one layer is the electronic heating layer and at least one layer is the photon absorbing layer.

Each nozzle system 40 includes, but is not limited to, an orifice 42, an orifice layer 44, a fluid (ink) chamber 46, a barrier layer 48, a transparent substrate 50, and the heating layer 38A . . . 38H. A portion of one of the heating layers 38A . . . 38H is positioned adjacent the ink chamber 36. In particular, a portion of the electric heating layer is disposed in each nozzle system 40, while each nozzle system 40 has a photon absorbing layer that can be activated independently of the photon absorbing layers for other nozzle systems 40.

The ink chamber 36 is capable of holding a volume of fluid (for example, ink) (not shown) such as, but not limited to, pigment-based inkjet inks and/or dye-based inkjet inks. These can include black ink and inks having a plurality of colors such as, but not limited to, cyan, yellow, and magenta. The barrier layer 48 functions to separate the ink flow so that ink can be individually provided to each nozzle system 40. In one embodiment, barrier layer 48 can be made of materials such as, but not limited to, Kapton™, Upilex™, (3M Corp), or like material. The transparent substrate 50 is transparent to the laser energy 58 emitted by the laser system 20. In one embodiment, the transparent substrate 50 can be made of material such as, but not limited to, glass, quartz or like material.

When the heating layers 38A . . . 38H are activated (e.g., turned on electronically and/or through absorption of laser energy), the heating layers 38A . . . 38H input energy (i.e., heat) to cause the ink to increase in temperature. In particular, the electronic heating layer is capable, upon electrical activation, of heating the ink in the ink chamber 46 for a specific area 36A . . . 36H. The photon absorbing layer is capable, upon activation by laser energy, of heating the ink in the ink chamber 46 for a specific nozzle system 40 located in a specific area 36A . . . 36H.

The electronic heating layers of the heating layers 38A . . . 38H are positioned so that each electronic heating layer overlaps a portion of the adjacent area. For example, the electronic heating layer in heating layer 38A overlaps a portion of area 36B. Thus, activating the electronic heating layer of heating layer 38A causes the ink in area 36A to be heated, while also heating the ink in the overlapped portion of area 36B. In particular, the ink in the nozzle systems 40 in the portion of the overlapped area 36B is heated. Heating the ink in this manner allows portions of the ink to be heated instead of heating the entire volume of ink. Also, the overlapping scheme of the electronic heating layers assists in generating a continuous thermal wave to proceed from area to area (i.e., from area 36A to 36B and so on).

The electronic heating layer in the heating layer 38 in each area 36A . . . 36H can be activated by the print control system 16 in accordance with print information corresponding to the information to be printed onto the media. The electronic heating layers of the heating layers 38A . . . 38H may be heated in a sequential or non-sequential manner, depending on the nozzle systems that are to eject ink on the media at the give time, from the first end 32 to the second end 34 of the page-wide array printhead assembly 30. In particular, the print control system 16 activates the electronic heating layer in heating layer 38A, then activates the electronic heating layer in heating layer 38B, and so on, in a sequential manner across the page-wide array printhead assembly 30. As subsequent electronic heating layers in heating layers 38A . . . 38H are activated, the previously activated electronic heating layer is deactivated (i.e., turned off). In other words, a thermal wave moves through the ink from the first end 32 to the second end 34 of the page-wide array printhead assembly 30, as opposed to heating the entire volume of ink in the page-wide array printhead assembly 30.

The page-wide array printhead assembly 30 is disposed adjacent the laser system 20. The laser system 20 is operatively scanned or stepped across the page-wide array printhead assembly 30 and transmits laser energy 58 to the photon absorption layer of the heating layers 38A . . . 38H of selected nozzle systems 40 in accordance with the print information. As discussed above, the photon absorption layer absorbs the laser energy and converts the laser energy into heat, which is used to heat the ink in the ink chamber 46.

The print control system 16 controls the laser system 20 and synchronizes the scan of the laser system 16 with the sequential activation of the electronic heating layers of the heating layers 38A . . . 38H across the page-wide array printhead assembly 30 in accordance with the printing information. The synchronization includes timing the scan of the laser system 20 to follow the activation of the electronic heating layers across the page-wide array printhead assembly 30. The print information indicates which nozzle systems 40 (i.e., selected nozzle systems) to pulse with the laser system 20 as it scans the page-wide array printhead assembly 30. The print information includes information describing print indicia that are to be formed on the media. The print indicia include, but are not limited to, characters, graphics, and photographs. The page-wide array printhead assembly forms the print indicia in a sequential manner as the media moves relative to the page-wide array printhead assembly 30 and as the laser system 20 scans the page-wide array printhead assembly 30.

It should be noted, that in other embodiments, a page wide array 18 may move with respect to the media. In such embodiments, either or both the page wide array 18 and the media may move with respect to each other.

The graph in FIG. 3 illustrates a representative energy curve 62 for ejecting ink from a thermal inkjet device. The graph plots energy input (heating) into a volume of ink in a thermal inkjet device as a function of drop volume ejected. The energy curve 62 shows a lower knee 64 (lower threshold) and an upper knee 66 (upper threshold). The lower knee 64 is the area of the energy curve just before the energy curve 62 curves up, while the upper knee 66 is the area of the energy curve where it flattens out. Movement along the energy curve from the lower knee to the upper knee indicates that the energy inputted into the ink volume causes a volume of ink to be ejected from the thermal inkjet device. The ratio 68 of the lower knee 64 and the upper knee 66 is about 1 to 1.2. The advantage of heating to about the lower knee, is that a small amount of energy can then be utilized to heat the ink or fluid to the upper knee. This reduction in energy allows for heating to occur faster and with less energy than with traditional ink ejection systems that utilize optical or laser energy to heat ink or fluid for ejection.

The information from the energy curve can be used in the design of the page-wide array print system 10. In general, the ink in the ink chamber 46 can be heated to a lower knee threshold by the electronic heating layers of the heating layers 38A . . . 38H of the nozzle systems 40. The lower knee threshold represents a position on the energy curve near the lower knee 64. The lower knee threshold can be defined, for example, as sufficient energy to be about 50% to 99%, about 70% to 99%, about 80% to 99%, about 90% to 99%, or about 90% of the inputted energy to reach the lower knee.

Then, the laser system 20 emits laser energy 58 at the photon absorbing layer of selected nozzle systems 40, which absorbs the laser energy 58. The laser energy 58 from the laser system 20 is sufficient to heat the ink to an upper knee threshold. A known volume of ink is ejected from the orifice 42 of selected nozzle system 40 when the energy inputted into the ink reaches the upper knee threshold. The upper knee threshold represents a position on the energy curve near the lower knee 64. The upper knee threshold can be defined as about 101% to 150%, about 101% to 130%, about 101% to 125%, or about 120% of the upper knee.

In other words, the electrical heating layers of the heating layers 38A . . . 38H heat the ink to a first level on the energy curve and the laser system 20 heats the ink from the first level to a second level on the energy curve. Using a two-part heating process with heating layers 38A . . . 38H and the laser system 20 results in the laser system 20 having to input less total energy to eject the ink drop than if the laser system 20 is used without the assistance of the electric heating layer. This is in contrast to other laser driven systems that use the laser system to provide all of the energy to eject the ink drop.

As indicated above, the print control system 16 synchronizes the scan of the laser system 20 across the page-wide array printhead assembly 30 with sequential activation of the electrical heating layers of the heating layers 38A . . . 38H across the page-wide array printhead assembly 30. For example, the electrical heating layer in heating layer 38A of area 36A is activated by the print control system 16 to heat the ink in each nozzle system 40 in area 36A to the lower knee threshold. Once the ink in each nozzle system 40 is heated to the lower knee threshold, the print control system 16 instructs the laser system 20 to emit laser energy at selected nozzle systems 20 as the laser system 20 scans across area 36A. The photon absorbing layers of the selected nozzle systems 20 absorb the laser energy and the energy is transferred into the ink, which inputs sufficient energy to reach the upper knee threshold. As a result of the ink having sufficient energy to reach the upper knee threshold, a known volume of ink is ejected from the selected nozzle system 20. The same process occurs for each of the selected nozzle systems 20 in area 36A as the laser system 20 scans across area 36A. Once the laser system scan completes emitting laser energy at the selected nozzle systems 20 in area 36A, the electrical heating layer in heating layer 38A is deactivated and the ink in the nozzle systems 40 of area 36A is allowed to cool.

Next, the print control system 16 activates the electrical heating layer in heating layer 38B of area 36B to heat the ink in each of the nozzle systems 40 in area 36B. The electrical heating layer is activated once the laser system scan of area 36A is nearly complete. It should be noted that the electrical heating layer in heating layer 38A heats a portion of area 36B. Once the ink in each nozzle system 40 of area 36B is heated to the lower knee threshold, the print control system 16 instructs the laser system 20 to transmit laser energy at selected nozzle systems 40 in area 36B as the laser system 20 scans across area 36B. The photon absorbing layers of the selected nozzle systems 40 absorb the laser energy and the energy is transferred into the ink, which inputs sufficient energy to reach the upper knee threshold. As a result of the ink having sufficient energy to reach the upper knee threshold, a known volume of ink is ejected from the selected nozzle systems 20. The same process occurs for each of the selected nozzle systems 40 in area 36B. Once the laser system scan completes emitting laser energy at the selected nozzle systems 40, the electrical heating layer in heating layer 38B is deactivated and the ink in the nozzle systems 40 of area 36B is allowed to cool.

The same process occurs for each area 36C . . . 36H so that the ink in the selected nozzle systems 40 is heated to the lower knee threshold by the electrical heating layer in heating layers 36C . . . 36H. Subsequently, the ink in the selected nozzle systems 40 is heated from the lower knee threshold to the upper knee threshold, so that a volume of ink is ejected from the selected nozzle systems 40. The print control system repeats this process until the printing information is converted into print indicia on the printing material.

The areas 36A . . . 36H are individually activated so that the ink in the nozzle systems 40 in each area 36A . . . 36H is not at an elevated temperature for a significant length of time. This reduces the likelihood of spitting or drooling of the ink in the page-wide array printhead assembly 30. In addition, each area 36A . . . 36H is heated to the lower knee threshold to limit the amount of energy used by the laser system 20 to raise the ink to the upper knee threshold, which is more energy efficient than currently used techniques.

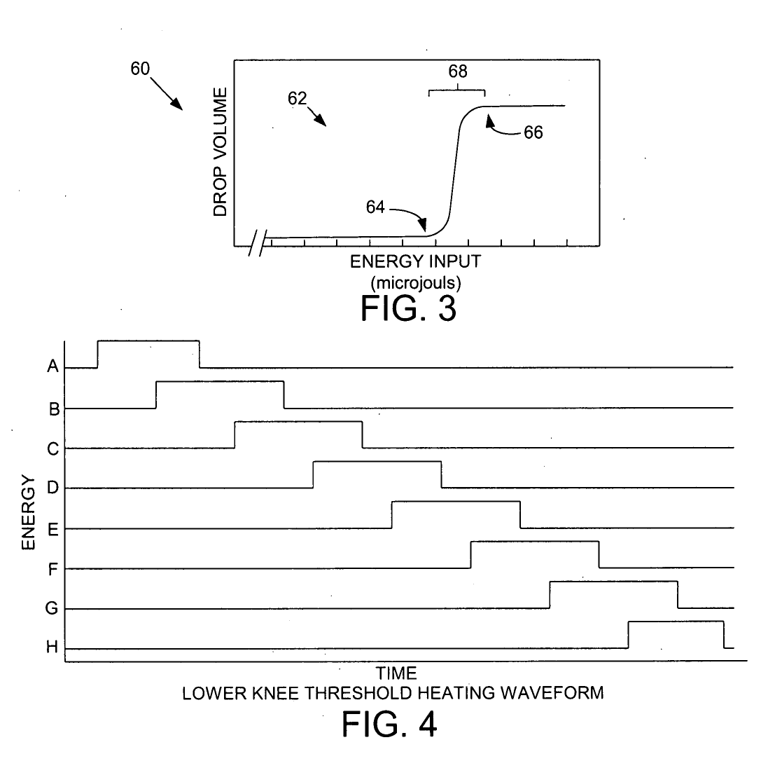

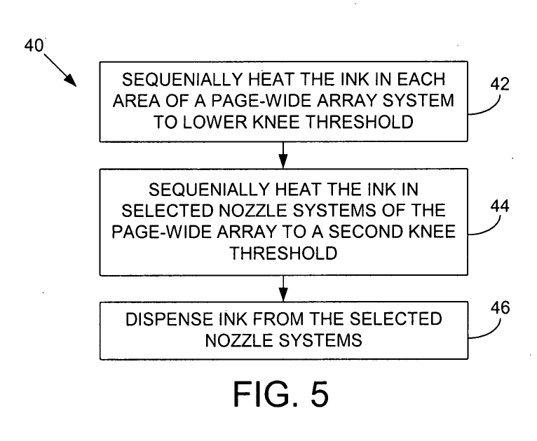

FIG. 4 is a graph of representative waveforms A . . . H for activating the electrical heating layers in heating layers 38A . . . 38H, respectively. Waveforms A . . . H indicate when the electrical heating layers in heating layers 38A . . . 38H are activated and then deactivated. Activation of the electrical heating layers in heating layers 38A . . . 38H according to the waveforms A . . . H causes a thermal wave to proceed from the first end 32 to the second end 34 of the page-wide array printhead assembly 30. The activation of the electrical heating layers in heating layers 38A . . . 38H precedes the scan of the laser system 20 to allow the ink in the nozzle systems 40 in each area to be heated to the lower knee threshold.

Thus, activating the electrical heating layers in heating layers 38A . . . 38H immediately prior to scanning laser system 20 across the page-wide array printhead assembly 30 enables the page-wide array print system 10 to eject ink drops in a controlled energy efficient manner.

Many variations and modifications may be made to the above-described embodiments. All such modifications and variations are intended to be included herein within the scope of this disclosure and protected by the following claims.

1. A method of ejecting a fluid, comprising the steps of:
heating the fluid to a lower threshold using electric heating;
heating the fluid to an upper threshold using laser energy; and
ejecting a volume of fluid after heating the fluid to the upper threshold.

2. The method of claim 1, further comprising heating the fluid to the lower threshold using electric heating immediately prior to heating the fluid to the upper threshold.

3. The method of claim 1, further comprising:
heating the fluid in nozzle systems located in a first area of a fluid ejection device to the lower threshold using an electric heating layer located in the first area;
directing laser energy from a laser system at a photon absorbing layer of selected nozzle systems in the first area; and
heating the fluid in the selected nozzle systems from the lower threshold to the upper threshold using energy absorbed by the photon absorbing layer.

4. The method of claim 3, further comprising:
heating the fluid in nozzle systems located in a second area to the lower threshold using the electric heating layer located in the second area;
directing laser energy from the laser system at a photon absorbing layer of selected nozzle systems in the second area; and
heating the fluid in the selected nozzle systems from the lower threshold to the upper threshold using energy absorbed by the photon absorbing layer.

5. The method of claim 3, further comprising:
activating the electric heating layer in each area to heat the fluid to the lower threshold in each area in a sequential manner from a first end of the page-wide array to a second end of the page-wide array;
synchronizing the emission of laser energy from the laser system with the activation of the electric heating layer;
scanning the laser from the first end to the second end of the page-wide array as the fluid in each area is sequentially heated to the lower threshold;
directing laser energy from the laser system at a photon absorbing layer of a plurality of selected nozzle systems in each area;
heating the fluid in the selected nozzle systems sequentially to the upper threshold as the laser scans across the page-wide array; and
ejecting a volume of fluid from the selected nozzle systems as the laser scans across the page-wide array.

6. The method of claim 3, wherein the electric heating layer and the photon absorbing layer comprise a same material.

7. The method of claim 3, wherein the electric heating layer and the photon absorbing layer are distinct layers.

8. A method of ejecting fluid from a page-wide array comprising a laser system operative to emit laser energy and a page-wide array comprising a plurality of areas, each area includes a plurality of nozzle systems and a heating layer, the heating layer includes an electric heating layer and a photon absorbing layer, each nozzle system includes the fluid, comprising the steps of:
heating the fluid in each area to a lower threshold using the electric heating layer corresponding to each area in a sequential manner from a first end of the page-wide array to a second end of the page-wide array;
directing laser energy from the laser system at the photon absorbing layer of a plurality of selected nozzle systems in each area beginning from the first end of the page-wide array to the second end of the page-wide array;
heating the fluid in the selected nozzle systems from the lower threshold to an upper threshold using the laser system; and
ejecting a volume of the fluid from the selected nozzle systems beginning from the first end of the page-wide array to the second end of the page-wide array.

9. The method of claim 8, further comprising:
synchronizing the emission of laser energy from the laser system with the activation of the electric heating layer.

10. A printhead, comprising:
a laser system operative to emit laser energy;
a page-wide array comprising a plurality of areas, each area includes a heating layer and a plurality of nozzle systems, the heating layer includes an electric heating layer and a photon absorbing layer, each heating component of a particular area overlaps the adjacent area, each nozzle system includes:
an orifice, a fluid chamber, and the photon absorbing layer, the fluid chamber includes a fluid, a portion of the electric heating layer is adjacent the fluid chamber and is operative to heat the fluid in the fluid chamber to the lower threshold temperature, the photon absorbing layer is adjacent the fluid chamber, the photon absorbing layer is operative to absorb laser energy emitted from the laser and heat the fluid in the fluid chamber from the lower threshold temperature to the upper threshold temperature.

11. The printhead of claim 10, wherein a fluid ejection system is operative to control the activation of the electric heating layers in a sequential manner from the first end of the page-wide array to the second end of the page-wide array, wherein the fluid ejection system is operative to control the scan rate of the laser system from the first end of the page-wide array to the second end of the page-wide array, wherein the page-wide array printing system synchronizes the activation of the electric heating layers and the scan rate of the laser system from the first end to the second end so that the fluid in the fluid chamber of a selected nozzle system is heated to the lower threshold temperature using the electric heating layer prior to the laser emitting laser energy directed to the photon absorbing layer of the selected nozzle systems.

12. The printhead of claim 10, wherein the page-wide array includes about 2000 to 8000 nozzle systems.

13. The printhead of claim 10, wherein the fluid includes black ink.

14. The printhead of claim 10, wherein the electric heating layer includes a resistive layer.

15. A printhead comprising:
a fluid chamber;
a nozzle in fluid communication with the fluid chamber to allow the fluid to be ejected from the fluid chamber;
means, responsive to an electric current, for heating the fluid in the fluid chamber to a first threshold; and
means, responsive to optical energy, for heating the fluid in the fluid chamber to a second threshold sufficient to eject ink from the fluid chamber.

16. The printhead of claim 15, comprising a plurality of fluid chambers and a plurality of nozzles associated with each fluid chamber, wherein the means responsive to the electric current heats the fluid in the plurality of fluid chambers and the means responsive to optical energy is operative to heat fluid at each nozzle.

17. The printhead of claim 15, comprising means for synchronizing the heating of the fluid in the fluid chambers to the lower threshold with the heating of the fluid from the lower threshold to the upper threshold.

18. The printhead of claim 15, comprising means for synchronizing the heating of the fluid in each fluid chamber in a sequential manner using the means responsive to the electric current with the heating of the fluid in each nozzle using the means responsive to the optical energy.

19. A printhead comprising:
a plurality of fluid chambers;
a plurality of nozzles, each associated with at least one of the plurality of fluid chambers;
a plurality of resistors, each coupled to receive electric current and corresponding to one of the plurality of fluid chambers; and
a plurality photon absorbing layers that generate heat in response to optical energy, each photon absorbing layer being coupled to the fluid chambers to eject fluid from the fluid chambers.

20. The printhead of claim 19, wherein the photon absorbing layer includes a plurality of sections each associated with a single nozzle.

21. The printhead of claim 19, further comprising a laser system operative to direct laser energy at each of the plurality of photon absorbing layers.

22. The printhead of claim 19, further comprising a print control system operative to synchronize the activation of the electric heating layers and the scan rate of the laser system to eject fluid from the fluid chambers.

23. The printhead of claim 19, wherein the plurality of resistors and plurality photon absorbing layers are substantially coplanar with each other.

24. The printhead of claim 19, wherein the plurality of resistors and plurality photon absorbing layers each form distinct layers.

25. The printhead of claim 24, wherein the plurality of resistors are each adjacent to one of the plurality of fluid chambers and wherein the plurality of photon absorbing layers are separated from the fluid ejection chambers by the plurality of resistors.
